(19) United States
(12) Patent Application Publication
(10) Pub. No.: US 2011/0268169 A1
(43) Pub. Date: Nov. 3, 2011

(54) EQUALIZATION APPARATUS AND BROADCASTING RECEIVING APPARATUS

(75) Inventors: Jun Mitsugi, Kanagawa (JP); Masami Aizawa, Kanagawa (JP)

(73) Assignee: KABUSHIKI KAISHA TOSHIBA, Tokyo (JP)

(21) Appl. No.: 13/033,669

(22) Filed: Feb. 24, 2011

(30) Foreign Application Priority Data
Apr. 28, 2010 (JP) 2010-104176

(51) Int. Cl. H04L 27/01; H04B 17/00

(52) U.S. Cl. 375/226; 375/232

(57) ABSTRACT

An equalization apparatus configured to receive a digitally modulated single carrier signal and perform multipath equalization in a frequency domain, including a frequency domain conversion unit which converts a received signal to a frequency domain signal, a channel estimation unit configured to estimate a channel response in a frequency domain from the received signal, an equalization weight calculation unit which calculates an equalization weight from the channel estimate value in the frequency domain, an equalization filter which receives the frequency domain signal from the frequency domain conversion unit and the equalization weight from the equalization weight calculation unit and performs equalization processing and a time domain conversion unit which converts the frequency domain signal from the equalization filter to a time domain signal, wherein the equalization weight calculation unit includes a power calculation unit, a power value correction unit, a complex conjugate generator and a divider.

### CROSS-REFERENCE TO RELATED APPLICATION

This application is based upon and claims the benefit of priority from Japanese Patent Application No. 2010-104176 filed in Japan on Apr. 28, 2010; the entire contents of which are incorporated herein by reference.

### FIELD

Embodiments described herein relate generally to an equalization apparatus and a broadcasting receiving apparatus configured to be able to reduce noise emphasis to a minimum when a ZF method is adopted to calculate equalization weights.

### BACKGROUND

Multipath interference caused by reflected waves represents a critical problem in radio communication and a linear equalizer is a technique of suppressing such multipath interference. In recent years, a technique of blocking a plurality of transmission signals and equalizing time signals thereof in a frequency domain (hereinafter referred to as “FDE (frequency domain equalization)”) is proposed as one of equalization techniques for wideband single carrier communication. In the case of FDE, the transmitter side transmits n blocked data signals (n symbols) with a guard interval (hereinafter referred to as “GI”) such as a PN sequence added to the head thereof. The GI and n data signals constitute a frame. The receiving side removes the GI from the received frame and then converts the data block portion to a frequency domain. The receiving side then estimates a channel response in a time domain using the PN sequence, converts the channel response to the frequency domain and performs equalization processing using the channel response and the frequency domain.

An equalization apparatus that performs equalization processing is provided with a GI removing unit, a first frequency domain conversion unit, a channel estimation unit, an equalization weight calculation unit, an equalization filter and a time domain conversion unit. Of these units, the first frequency domain conversion unit converts the time domain signal resulting from removing the GI portion from the received signal to a frequency domain signal. The channel estimation unit is provided with a correlation processing unit, a PN sequence generation unit and a second frequency domain conversion unit. Of these units, the correlation processing unit performs correlation processing between the received signal and the PN sequence generated by the PN sequence generation unit and calculates a channel estimate value in the time domain. The equalization weight calculation unit calculates an equalization weight W(k) from the channel estimate value in the frequency domain calculated by the correlation processing unit and converted by the second frequency domain conversion unit.

A zero-forcing method (hereinafter referred to as “ZF method”) or minimum mean square error method (hereinafter referred to as “MMSE method”) is generally used to calculate an equalization weight. The equalization weight calculation unit outputs the calculated equalization weight to the equalization filter.

The equalization filter receives a frequency domain signal R(k) supplied from the first frequency domain conversion unit and the equalization weight W(k) supplied from the equalization weight calculation unit as input, performs equalization processing (complex multiplication) and outputs equalization data F(k).

F(k)=R(k)·W(k)k=1, 2, 3, . . . , n

The equalization filter outputs the equalization signal F(k) which is a frequency domain signal after the equalization processing to the time domain conversion unit, and the time domain conversion unit converts the equalization signal from the equalization filter to a time domain to output the equalization signal as a demodulated signal.

Among such FDE techniques, the ZF method in equalization weight calculation is simple, but the ZF method provokes a noise emphasis and thereby involves a problem that reception characteristics deteriorate considerably. On the other hand, the MMSE method can prevent a noise emphasis and therefore has excellent characteristics, but the MMSE method needs to estimate an amount of noise and the processing is very complicated.

Thus, there is a demand for realization of an equalization apparatus capable of reducing a noise emphasis to a minimum when adopting the ZF method to calculate equalization weights.

### BRIEF DESCRIPTION OF THE DRAWINGS

FIG. 1 is a block diagram illustrating an equalization apparatus according to a first embodiment of the present invention;

FIG. 2 is a diagram illustrating a frame configuration (time domain signal) of data transmitted using a frequency domain equalization technique;

FIG. 3 is a block diagram illustrating a conventional equalization weight calculation unit (ZF method);

FIG. 4 is a block diagram illustrating a conventional equalization weight calculation unit (MMSE method);

FIG. 5 is a diagram illustrating a relationship between a main wave and delay waves on the time axis;

FIG. 6 is a diagram illustrating a state in which a notch has occurred in a channel estimate value on the frequency axis based on the existence of a delay wave;

FIG. 7 is a block diagram illustrating an example of an equalization weight calculation unit of an equalization apparatus according to a first embodiment;

FIG. 8 is a graph illustrating output characteristics of a correction function in the equalization apparatus of the first embodiment;

FIG. 9 is a block diagram illustrating another example of the equalization weight calculation unit in the equalization apparatus of the first embodiment;

FIG. 10 is a block diagram illustrating an example of a correction function generator in an equalization apparatus according to a second embodiment of the present invention;

FIG. 11 is a diagram illustrating a first example (power value) of a channel estimate value in the frequency domain;

FIG. 12 is a diagram illustrating a second example (power value) of a channel estimate value in the frequency domain;

FIG. 13 is a diagram illustrating a third example (power value) of a channel estimate value in the frequency domain;

FIG. 14 is a block diagram illustrating an equalization apparatus according to a third embodiment of the present invention;

FIG. 15 is a block diagram illustrating an example of the equalization weight calculation unit in FIG. 14;

FIG. 16 is a diagram illustrating a method of calculating MER;

FIG. 17 is a block diagram illustrating an example of the threshold generator in FIG. 15;

FIG. 18 is a flowchart of threshold correction; and

FIG. 19 is a block diagram illustrating a broadcasting receiving apparatus according to an embodiment of the present invention.

### DETAILED DESCRIPTION

An equalization apparatus according to an embodiment of the present invention is an equalization apparatus configured to receive a digitally modulated single carrier signal and perform multipath equalization in a frequency domain and is provided with a frequency domain conversion unit, a channel estimation unit, an equalization weight calculation unit, an equalization filter and a time domain conversion unit.

The frequency domain conversion unit converts a received time domain signal to a frequency domain signal. The channel estimation unit estimates a channel response in a frequency domain from the received signal. The equalization weight calculation unit calculates an equalization weight from the channel estimate value in the frequency domain. The equalization weight calculation unit calculates an equalization weight from the channel estimate value in the frequency domain. The equalization filter performs equalization processing on the frequency domain signal from the frequency domain conversion unit using the equalization weight from the equalization weight calculation unit. The time domain conversion unit converts the frequency domain signal subjected to the equalization processing by the equalization filter to a time domain signal.

The equalization weight calculation unit is provided with a power calculation unit, a power value correction unit, a complex conjugate generator and a divider.

The power calculation unit calculates a power value of the channel estimate value. The power value correction unit compares the power value from the power calculation unit with a threshold and outputs a power value corrected according to the result. The complex conjugate generator generates a conjugate complex number of the channel estimate value. The divider divides the conjugate complex number by the corrected power value and outputs the division result as an equalization weight.

Hereinafter, embodiments of the present invention will be described in detail with reference to the accompanying drawings.

### First Embodiment

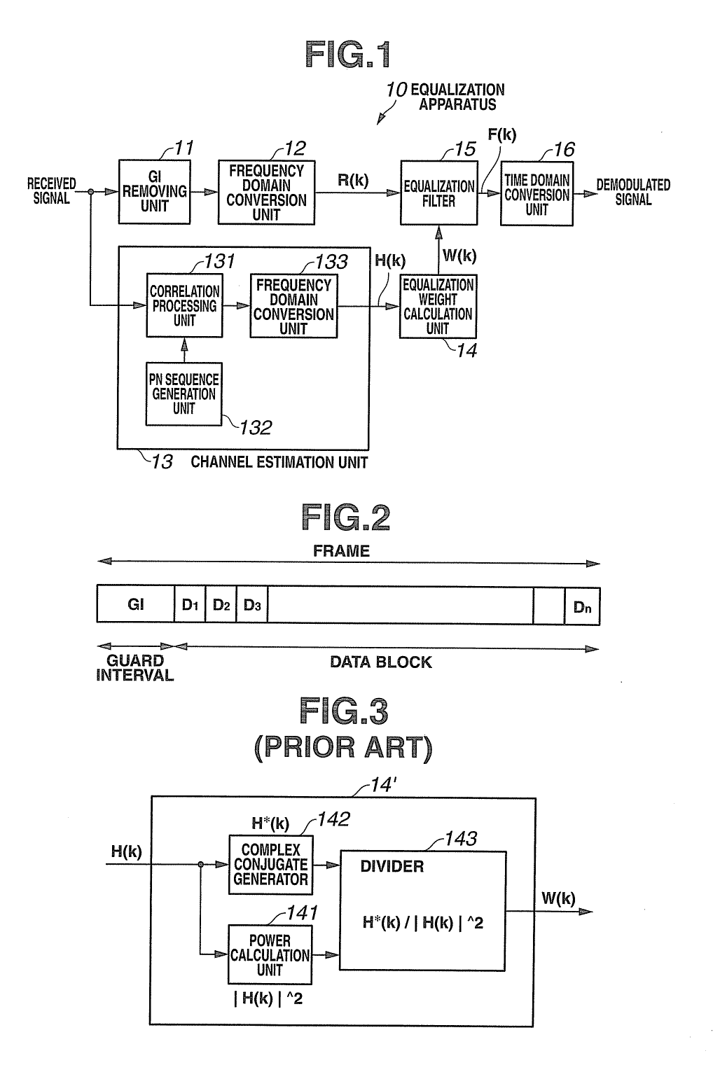

FIG. 1 illustrates a block diagram of an equalization apparatus according to a first embodiment of the present invention and FIG. 2 illustrates a frame configuration (time domain signal).

In the case of a frequency domain equalization (FDE) technique, the transmitter side transmits a blocked data signal (n symbols) with a guard interval (GI) such as a PN sequence added to the head thereof as shown in FIG. 2. This will be referred to as a “frame” hereinafter. The receiving side removes the GI portion from the received frame and then converts the rest of the data block portion to a frequency domain. The receiving side then estimates a channel response in the time domain using the PN sequence, converts the channel response to the frequency domain and performs equalization processing using these.

An equalization apparatus 10 shown in FIG. 1 is provided with a GI removing unit 11, a frequency domain conversion unit 12, a channel estimation unit 13, an equalization weight calculation unit 14, an equalization filter 15 and a time domain conversion unit 16.

The GI removing unit 11 receives a received signal as input, removes a GI portion from the received frame and outputs the received signal from which the GI portion has been removed to the frequency domain conversion unit 12.

The frequency domain conversion unit 12 receives the received signal outputted from the GI removing unit 11 without GI as input and converts the received signal to a frequency domain signal. The frequency domain conversion unit 12 outputs the frequency domain signal (R(k): k=1, 2, 3, . . . , n) to the equalization filter 15.

The channel estimation unit 13 is provided with a correlation processing unit 131, a PN sequence generation unit 132 and a frequency domain conversion unit 133.

The PN sequence generation unit 132 generates the same PN sequence as that on the transmitter side and outputs the PN sequence to the correlation processing unit 131.

The correlation processing unit 131 performs correlation processing between the received signal and the PN sequence and calculates a channel estimate value in the time domain. The correlation processing unit 131 outputs the calculated channel estimate value to the frequency domain conversion unit 133.

The frequency domain conversion unit 133 converts the channel estimate value in the time domain to a channel estimate value in the frequency domain and outputs the channel estimate value H(k) in the frequency domain to the equalization weight calculation unit 14.

The equalization weight calculation unit 14 calculates an equalization weight W(k) from the channel estimate value in the frequency domain. A ZF method (Zero Forcing) or minimum mean square error method (MMSE) is generally used to calculate equalization weights. The ZF method and the MMSE method will be described later. The equalization weight calculation unit 14 outputs the calculated equalization weight to the equalization filter 15.

The equalization filter 15 receives the frequency domain signal supplied from the frequency domain conversion unit 12 and the equalization weight supplied from the equalization weight calculation unit 14 as input, performs equalization processing (complex multiplication) and outputs equalization data F(k).

F(k)=R(k)·W(k)k=1, 2, 3, . . . , n

The equalization filter 15 outputs the equalization signal F(k) which is the frequency domain signal after the equalization processing to the time domain conversion unit 16.

The time domain conversion unit 16 converts the equalization signal supplied from the equalization filter 15 to a time domain signal and outputs the signal as a demodulated signal.

A conventional equalization weight calculation unit 14′ when a ZF method is used to calculate an equalization weight is provided with a power calculation unit 141, a conjugate complex number generator (hereinafter referred to as “complex conjugate generator”) 142 and a divider 143 as shown in FIG. 3 and an equalization weight W(k) is expressed by the following equation.

W(k)=H*(k)/{|H(k)|̂2}k=1, 2, 3, . . . , n

where, H(k) denotes a channel estimate value in the frequency domain, H*(k) denotes a conjugate complex number and |·| denotes an absolute value.

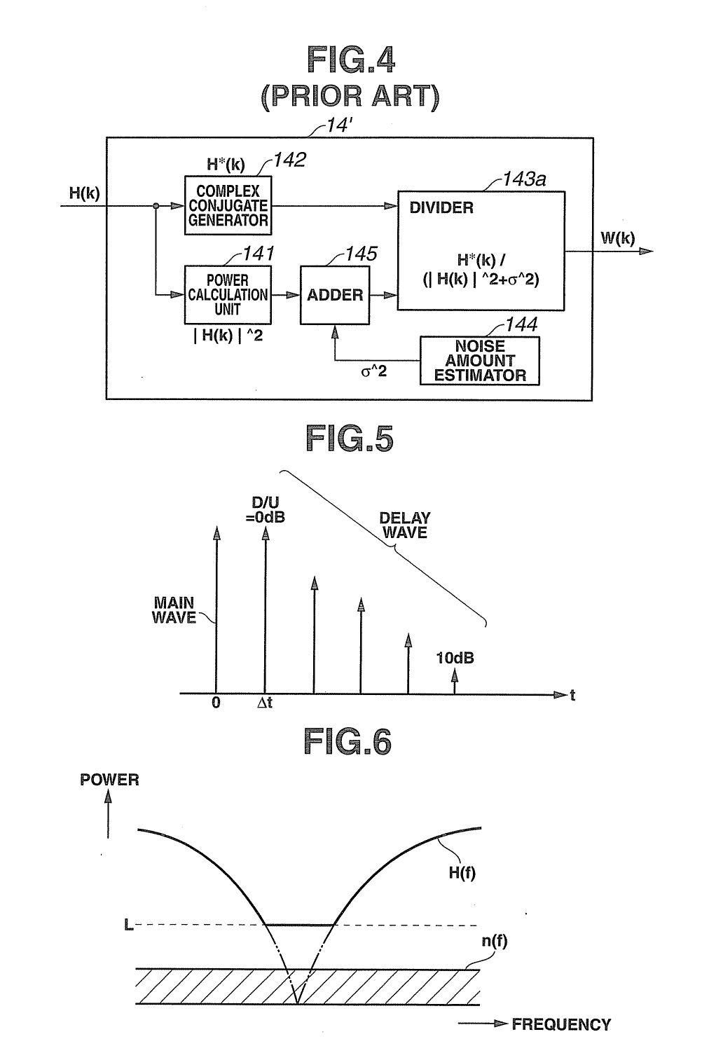

On the other hand, a conventional equalization weight calculation unit 14′ when an MMSE method is used to calculate an equalization weight is provided with a noise amount estimator 144, an adder 145, a power calculation unit 141, a complex conjugate generator 142 and a divider 143a as shown in FIG. 4, and an equalization weight W(k) is expressed by the following equation.

W(k)=H*(k)/{|H(k)|̂2+σ̂2}k=1, 2, 3, . . . , n

where, σ̂2 denotes noise power.

Transmission signals transmitted from the transmitter side include direct waves that directly arrive at the receiving side and delay waves that arrive after being reflected or scattered by buildings or the like and are called “multipath.” Normally, a direct wave having a high power peak is a main wave and there are one or more delay waves which have different delay times. Note that “main wave” and “delay wave” are generally referred to as “main path” and “delay path”, respectively.

FIG. 5 is a diagram illustrating a relationship between a main wave and delay waves on the time axis.

In FIG. 5, the horizontal axis shows time t and the vertical axis shows power. When viewed in a delay profile on the time axis, if, for example, there are a plurality of delay waves having different delay times with respect to a main wave as shown in FIG. 5, the power peak of the main wave is substantially the same as the power peak of the delay wave which is delayed by a time Δt, and a power ratio D/U of the main wave to the delay wave is 0 dB. When the power of the delay wave is 1/10 of the power of the main wave, D/U is 10 dB. When there is a delay wave having a large power value, such a wave has a large effect (interference) on the main wave.

This will be considered in terms of a channel estimate value H(f) on the frequency axis obtained as a result of carrying out correlation processing between the received signal and a known signal such as a PN sequence, which is the same as the GI portion included therein.

FIG. 6 is a diagram illustrating a state in which a notch has occurred in the channel estimate value on the frequency axis based on the existence of a delay wave.

The notch is produced as having a quasi-V-shaped characteristic (portion shown by a solid line and two-dot dashed line) shown in FIG. 6. The number of notches increases as the delay time of the delay wave increases. For example, every time the delay time of the delay wave increases by one symbol unit, the number of notches is incremented by one. Equalization corresponds to eliminating delay waves from a received signal arriving through multipath and leaving only one wave and means eliminating drops (that is, notches) in the channel estimate value H(f) on the frequency axis as shown in FIG. 6. In FIG. 6, the horizontal axis shows a frequency f and the vertical axis shows power P.

Assuming a transmission signal in the frequency domain is S(f), a received signal in the frequency domain is R(f) and a channel response value in the frequency domain is H(f), there is the following relationship:

$$\begin{matrix}R ( f ) = H ( f ) \cdot S ( f ) \\ Therefore , & ( 1 ) \\ \begin{matrix}S ( f ) = R ( f ) / H ( f ) \\ = R ( f ) \cdot {H}^{*} ( f ) / H ( f ) \cdot {H}^{*} ( f ) \\ = R ( f ) \cdot {H}^{*} ( f ) / \vert H ( f ) \vert \hat{} 2\end{matrix} & ( 2 )\end{matrix}$$

where, ̂2 denotes the square and |H(f)|̂2 denotes a power value of H(f).

Equations (1) and (2) mean extraction of the transmission signal S(f) when there is no noise, but noise is called “white color noise” on the frequency axis and noise exists uniformly over the entire frequency band. If equations (1) and (2) are rewritten in consideration of noise n(f) in the frequency domain, they will be the following equations, respectively.

$$\begin{matrix}R ( f ) = H ( f ) \cdot S ( f ) + n ( f ) & ( 3 ) \\ \begin{matrix}S ( f ) = ( R ( f ) - n ( f ) ) / H ( f ) \\ = ( R ( f ) - n ( f ) ) \cdot {H}^{*} ( f ) / H ( f ) \cdot {H}^{*} ( f ) \\ = \{ R ( f ) \cdot {H}^{*} ( f ) / \vert H ( f ) \vert \hat{} 2 \} - \{ ( n ( f ) \cdot {H}^{*} ( f ) ) / \vert H ( f ) \vert \hat{} 2 \}\end{matrix} & ( 4 )\end{matrix}$$

Since (n(f)·H*(f))/|H(f)|̂2 including a noise component increases when the channel estimate value (power value)|H(f)|̂2 decreases, and a noise emphasis occurs and the equalization performance deteriorates.

Thus, when a single carrier based signal is equalized through multipath in the frequency domain, the data unit R(f) converted to the frequency domain is divided (zero-forcing) by the channel response value H(f) converted to the frequency domain. However, when, for example, a delay wave of substantially the same level as that of the main wave exists (D/U=0), a noise emphasis occurs at a frequency where the channel estimate value (power value)|H(f)|̂2 in the frequency domain decreases and the equalization performance deteriorates. Thus, embodiments of the present invention change the value to be divided, when zero-forcing is applied, to a correction value corresponding to the channel response value H(f) and thereby improves the equalization performance.

Explaining with FIG. 6, by raising the power value of the notch portion (portion shown by the two-dot dashed line) of the channel response value H(f) to the level shown by reference character L, it is possible to suppress the noise emphasis at the notch portion where H(f) drops drastically and thereby improve the equalization performance.

If no noise exists, S(f) can be extracted, but noise is called “white color noise” and exists in the whole band on the frequency axis. However, if a deep notch which may cause deterioration exists in the channel response value H(f), H(f) approximates to 0 during equalization, and the noise component included in R(f) as shown in equation (4) also increases drastically.

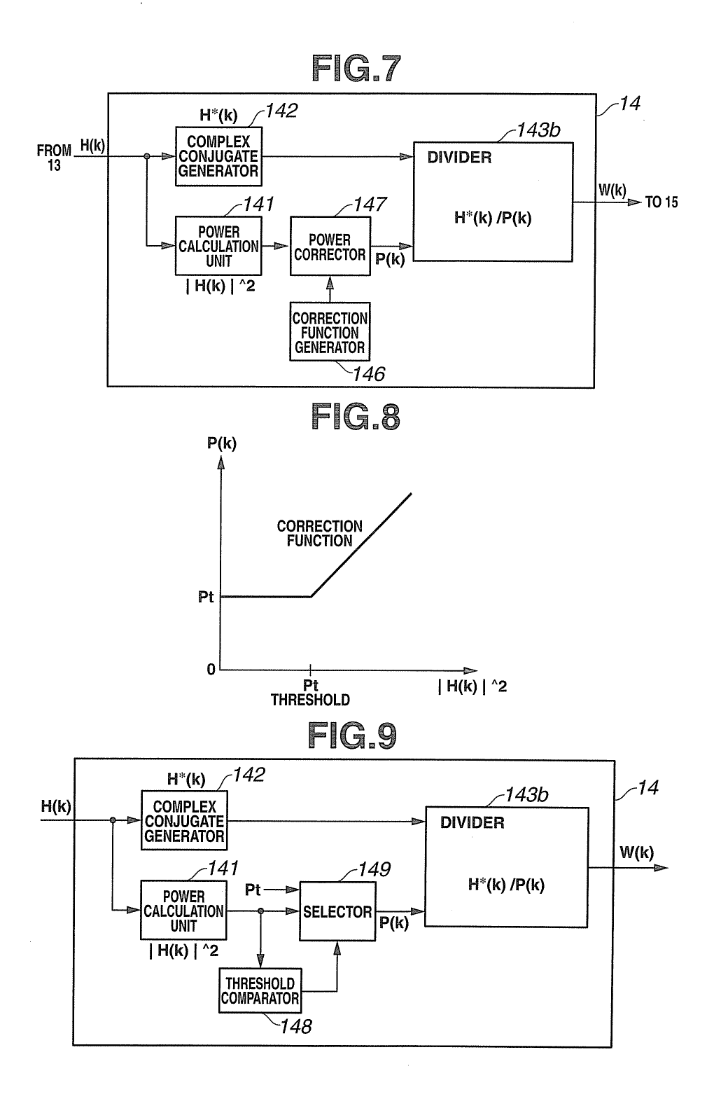

FIG. 7 is a block diagram illustrating an example of the equalization weight calculation unit in the equalization apparatus of the first embodiment, FIG. 8 is a graph illustrating output characteristics of the correction function in the equalization apparatus of the first embodiment and FIG. 9 is a block diagram illustrating another example of the equalization weight calculation unit in the equalization apparatus of the first embodiment.

As shown in FIG. 7, the equalization weight calculation unit 14 of the first embodiment of the present invention is provided with a power calculation unit 141, a correction function generator 146, a power corrector 147, a complex conjugate generator 142 and a divider 143b. The correction function generator 146 and the power corrector 147 constitute a power value correction unit.

The power calculation unit 141 calculates a power value of the channel estimate value from the channel estimation unit 13. The correction function generator 146 generates a correction function. The complex conjugate generator 142 receives the channel estimate value H(f) as input from the channel estimation unit 13 and generates a conjugate complex number thereof.

The power corrector 147 corrects the power value from the power calculation unit 141 using the correction function from the correction function generator 146, compares the power value from the power calculation unit 141 with a threshold and outputs, when the power value is smaller than the threshold, a constant value equal to or above the threshold as the corrected power value. The divider 143b divides the conjugate complex number of the channel estimate value by the corrected power value P(k) from the power corrector 147 and outputs the division result as an equalization weight W(k).

The power corrector 147 will be described further.

Using the correction function in FIG. 8 supplied from the correction function generator 146, the power corrector 147 compares the power value |H(k)|̂2 outputted from the power calculation unit 141 with a threshold Pt and outputs, when the power value is smaller than the threshold Pt, the corrected output value Pt from the correction function generator 146 (see FIG. 8). That is, the power corrector 147 selects Pt when the power value |H(k)|̂2 from the power calculation unit 141 is smaller than the threshold Pt and selects and outputs |H(k)|̂2 as is when |H(k)|̂2 is equal to or above the threshold Pt.

P(k)=Pt(where |H(k)|̂2<Pt)

P(k)=|H(k)|̂2(otherwise, i.e., when |H(k)|̂2≧Pt)

Using the correction function P(k) shown in FIG. 8, the equalization weight calculation unit 14 calculates an equalization weight W(k).

W(k)=H*(k)/P(k)k=1, 2, 3, . . . , n

The correction function prevents any division by a value smaller than the threshold Pt from being carried out, thereby suppresses the noise emphasis and improves the equalization performance. Furthermore, it is possible to narrow the dynamic range of the equalization weight W(k) and makes mounting easier.

Here, the equalization weight calculation unit 14 may also be configured so as to include the power calculation unit 141, a threshold comparator 148, a selector 149, the complex conjugate generator 142 and the divider 143b as shown in FIG. 9. The threshold comparator 148 and the selector 149 constitute a power value correction unit.

The power calculation unit 141 calculates a power value of the channel estimate value from the channel estimation unit 13. The complex conjugate generator 142 receives the channel estimate value from the channel estimation unit 13 as input and generates a conjugate complex number thereof.

The threshold comparator 148 compares the power value from the power calculation unit 141 with the threshold Pt and outputs a signal indicating whether or not the power value is smaller than the threshold.

The selector 149 inputs the power value from the power calculation unit 141 to one input end thereof and inputs the same value as the threshold Pt used in the threshold comparator 148 to the other end and selects and outputs the comparison result of the threshold comparator 148 to any one of the two input ends as a selected signal.

The divider 143b divides a conjugate complex number of the channel estimate value by the corrected power value from the selector 149 and outputs the division result as an equalization weight.

To be more specific, the threshold comparator 148 compares the power value |H(k)|̂2 from the power calculation unit 141 with the threshold Pt and the selector 149 selects Pt when |H(k)|̂2 is smaller than Pt or selects and outputs |H(k)|̂2 as is when |H(k)|̂2 is equal to or above the threshold Pt.

The first embodiment compares the power value of the channel estimate value with a predetermined threshold of the correction function, corrects, when the power value is smaller than the threshold, the power value as a notch portion so as to obtain a constant power value equal to or above the threshold, and can thereby reduce a noise emphasis and reproduce high definition video and speech.

### Second Embodiment

A second embodiment of the present invention is different from the first embodiment in that the threshold Pt in the correction function of the first embodiment is adaptively controlled according to multipath characteristics.

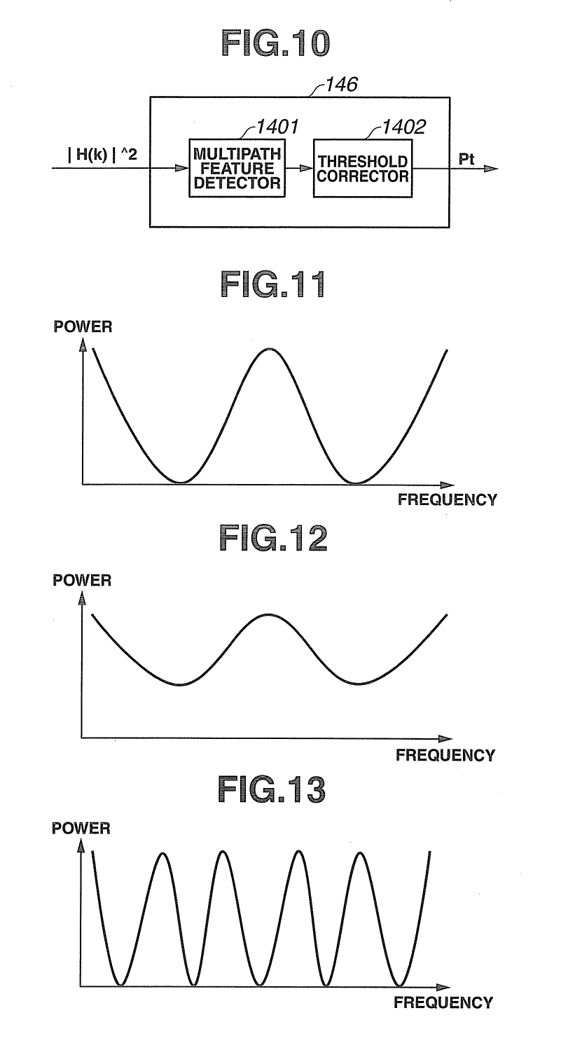

FIG. 10 shows an example of a correction function generator of an equalization apparatus according to the second embodiment of the present invention. To be more specific, the threshold Pt used in the correction function generator 146 and the power corrector 147 shown in FIG. 7 of the first embodiment or the threshold Pt used in the threshold comparator 148 and the selector 149 shown in FIG. 9 is adaptively controlled according to multipath characteristics. In the second embodiment, the same components as those in the first embodiment will be described with the same reference numerals assigned thereto.

FIG. 11 illustrates a first example (power value) of a channel estimate value in the frequency domain, FIG. 12 illustrates a second example (power value) of a channel estimate value in the frequency domain and FIG. 13 illustrates a third example (power value) of a channel estimate value in the frequency domain.

It is more preferable to adaptively control the threshold Pt of the correction function according to multipath characteristics. For example, the threshold Pt is set to be different between the cases where the channel estimate value |H(k)|̂2 (power value) in the frequency domain is as shown in FIG. 11 and FIG. 12. That is, when the drop on the frequency axis is large as shown in FIG. 11, demodulation is more difficult compared to the case where the drop on the frequency axis is small as shown in FIG. 12. Conversely, demodulation in the environment in FIG. 11 is only possible in a situation in which C/N is better than that in the environment in FIG. 12, and therefore a threshold Pt8 in the environment in FIG. 11 is set to a smaller value than a threshold Pt9 in the environment in FIG. 12 accordingly.

Pt8<Pt9

This makes it possible to improve performance according to the multipath environment.

As shown in FIG. 10, the correction function generator 146 is provided with a multipath feature detector 1401 and a threshold generator 1402, receives a channel estimate value (power value)|H(k)|̂2 in the frequency domain as input and generates a threshold power value Pt.

The multipath feature detector 1401 detects an average power value E(|H(k)|̂2), a maximum power value Max(|H(k)|̂2), a minimum power value Min(|H(k)|̂2), the number of ripples (number of notches) Nnum(|H(k)|̂2) or the like of the channel estimate value.

The threshold generator 1402 generates a threshold power Pt using information from the multipath feature detector 1401.

As the method of generating a threshold, for example, 1/X of the average power value may be set as a threshold using average power value information.

Pt=E(|H(k)|̂2)/X(where, X>1)

where, E(·) means an average value.

Furthermore, if a difference between the maximum power value and the minimum power value is expressed as D(Max(|H(k)|̂2), Min(|H(k)|̂2)), the difference is as follows:

D(Max(|H(k)|̂2),Min(|H(k)|̂2))=Max(|H(k)|̂2)−Min(|H(k)|̂2)

Using this, the threshold Pt is set as follows:

Pt=E(|H(k)|̂2)/(D(Max(|H(k)|̂2),Min(|H(k)|̂2))·X(where, X>1)

Furthermore, as for the number of ripples, if the number of ripples of the channel response value is large as shown in FIG. 13, demodulation becomes more difficult compared to the case in FIG. 11, and therefore the threshold power may also be set in inverse proportion to the number of ripples Nnum(|H(k)|̂2). That is,

Pt=E(|H(k)|̂2)/(Nnum(|H(k)|̂2)·X)(where, X>1)

Furthermore, a threshold may also be generated using all the average value, maximum value, minimum value and number of ripples. That is,

Pt=E(|H(k)|̂2)/(D(Max(|H(k)|̂2),Min(|H(k)|̂2))·Nnum(|H(k)|̂2)·X(where, X>1)

The second embodiment adaptively controls the threshold of the correction function to calculate an equalization weight according to multipath characteristics, and can thereby realize more suitable equalization processing and reproduce high definition video and speech.

### Third Embodiment

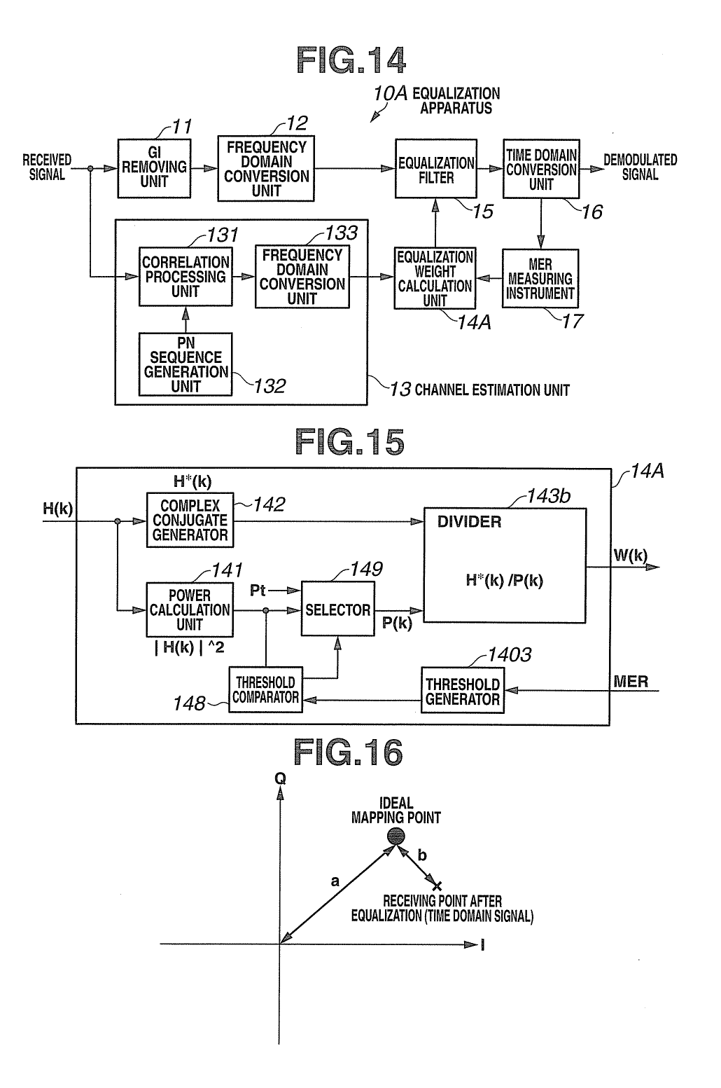

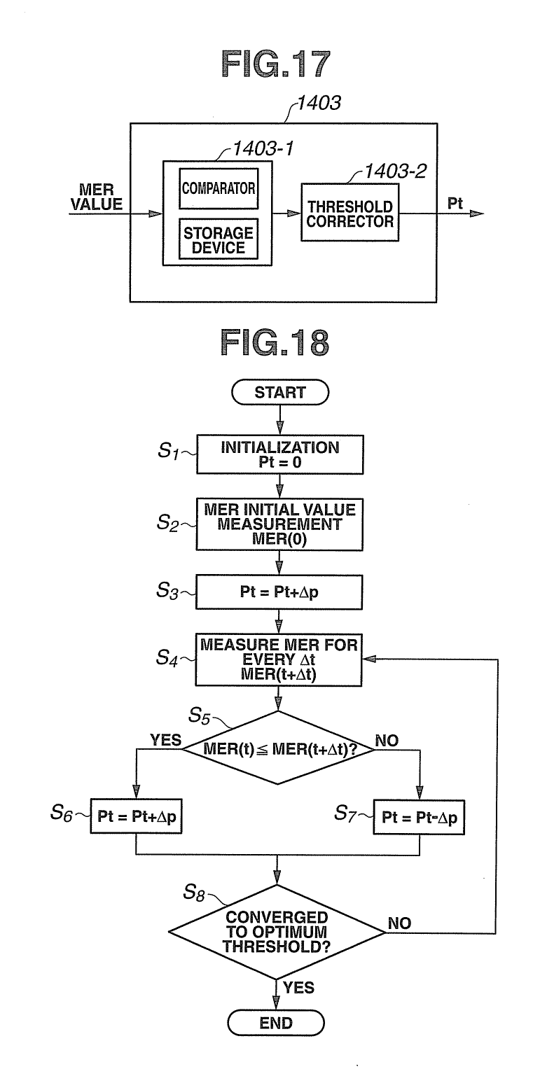

FIG. 14 is a block diagram illustrating an equalization apparatus according to a third embodiment of the present invention, FIG. 15 is a block diagram illustrating an example of the equalization weight calculation unit in FIG. 14, FIG. 16 is a diagram illustrating a method of calculating MER, FIG. 17 is a block diagram illustrating an example of the threshold generator in FIG. 15 and FIG. 18 is a flowchart of threshold correction. In the third embodiment, the same components as those in the first embodiment and the second embodiment will be described with the same reference numerals assigned thereto.

An equalization apparatus 10A shown in FIG. 14 is provided with a GI removing unit 11, a frequency domain conversion unit 12, a channel estimation unit 13, an equalization weight calculation unit 14A, an equalization filter 15, a time domain conversion unit 16 and an MER measuring instrument 17.

The third embodiment of the present invention is different from the equalization apparatus of the first embodiment in that the output of the equalization apparatus shown in the first embodiment is fed back to the equalization weight calculation unit and a threshold is generated according to the amount of feedback control. The MER measuring instrument 17 is provided for that purpose.

As shown in FIG. 15, the equalization weight calculation unit 14A is provided with a power calculation unit 141, a threshold comparator 148, a selector 149, a complex conjugate generator 142, a divider 143b and a threshold generator 1403. The threshold comparator 148, the selector 149 and the threshold generator 1403 constitute a power value correction unit.

The MER measuring instrument 17 measures a modulation error ratio (hereinafter referred to as “MER”) of the output from the time domain conversion unit 16. As shown in FIG. 16, the MER measuring instrument 17 calculates MER from the following equation assuming that the distance between the output value from the time domain conversion unit 16 and an ideal mapping point is b and the distance from the origin to the ideal mapping point is a.

MER=â2/b̂2

The MER measuring instrument 17 calculates an average MER corresponding to one frame every Δt time (e.g., 1 frame) and outputs this average MER value to the equalization weight calculation unit 14.

The threshold generator 1403 corrects the threshold of the threshold comparator 148 using information from the MER measuring instrument 17.

As shown in FIG. 17, the threshold generator 1403 is provided with a comparator and storage device (memory) 1403-1 and a threshold corrector 1403-2 and receives an MER value from the MER measuring instrument 17 every Δt (1 frame). The threshold generator 1403 stores the received MER value in the storage device and compares a previous MER value with a latest MER value every Δt (1 frame) using the comparator. The threshold generator 1403 then outputs the comparison result to the threshold corrector 1403-2.

When the relationship between MER(t) at time t and MER(t+Δt) at time (t+Δt) is:

MER(t)≦MER(t+Δt)

the threshold corrector 1403-2 corrects the threshold used for the threshold comparator 148 as follows.

Pt=Pt+ΔP

On the other hand, if MER(t)>MER(t+Δt), the threshold corrector 1403-2 corrects the threshold used for the threshold comparator 148 as follows.

Pt=Pt−Δp

The threshold corrector 1403-2 performs the above described operation to correct the threshold of the threshold comparator 148. Alternatively, the threshold corrector 1403-2 outputs the corrected threshold Pt to the threshold comparator 148.

The equalization weight calculation unit 14A generates an equalization weight factor W(k) according to the corrected threshold.

FIG. 18 illustrates a flowchart of threshold correction.

First, an initial value of the threshold is set (step S1).

Pt=0

MER in this case is measured. MER(0) is set as an initial value (step S2).
After time Δt (1 frame), the threshold is set as follows (step S3).

Pt=Pt+Δp where Δp>0

MER(t+Δt) is then measured (step S4).
First, MER(Δt), Δt after t=0 is measured.
MER(t) is compared with MER(t+Δt) (step S5).
First, MER(0) is compared with MER(Δt).
If MER(0)≦MER(Δt), the threshold is corrected as follows (step S6).

Pt=Pt+ΔP

On the contrary, if MER(0)>MER(Δt), the threshold is corrected as follows (step S7).

Pt=Pt−Δp Where, if Pt<0, Pt=0.

By repeating the above described operation for every Δt, a check is made to see whether or not the value converges to an optimum threshold (step S8). The process ends when the value converges to the threshold or returns to step S4 otherwise.

As for a decision as to whether or not the value has converged to an optimum threshold, for example, about a threshold Pt when the decision result in step S5 is reversed in making a comparison of MER values every Δt and the threshold correcting operation in step S6 at the previous time is changed to the operation in S7 or on the contrary, a threshold Pt when the threshold correcting operation in step S7 is changed to the operation in S6, the threshold before or after the change may be determined as the optimum value.

The third embodiment calculates an MER (modulation error ratio) from the output of the equalization apparatus, adaptively controls the threshold of the correction function to calculate an equalization weight based on the calculated value, and can thereby realize more preferable equalization processing and reproduce high definition video and speech.

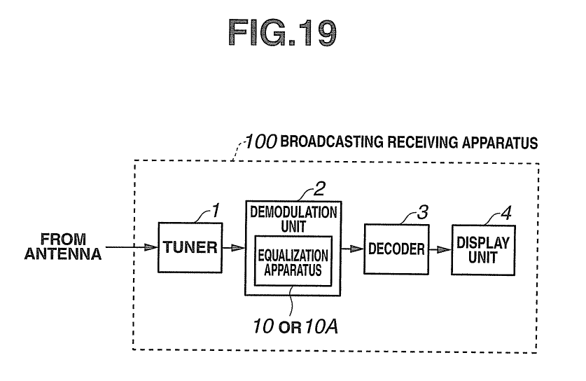

FIG. 19 illustrates a block diagram of a broadcasting receiving apparatus according to an embodiment mounted with the equalization apparatus according to the above described first to third embodiments.

A broadcasting receiving apparatus 100 includes a tuner 1 configured to select/receive a broadcast signal and a demodulation unit 2 provided with any one of the equalization apparatuses 10 and 10A described in the first to third embodiments configured to equalize a received signal from the tuner 1, demodulate the equalization data and output transport stream (hereinafter referred to as “TS”) data, a decoder 3 configured to decode the TS data and reproduce a video signal and a speech signal, and a display unit 4 configured to display/output the reproduced video signal and speech signal.

The demodulation unit 2 is provided, for example, with an A/D converter configured to convert an analog signal received by the tuner 1 to a digital signal, an orthogonal detector configured to convert the digital signal to a baseband band, the equalization apparatus 10 (or 10A) configured to equalize the received signal based on the result of channel estimation by the channel estimator, and a data demodulation unit configured to demodulate the equalization data and output TS data. Furthermore, the decoder 3 is provided, for example, with a TS decoder, a video decoder and a speech decoder.

According to the broadcasting receiving apparatus of such an embodiment, even when a ZF method is adopted as the method of calculating an equalization weight in the equalization apparatus, it is possible to suppress a noise emphasis and reproduce high definition video and speech.

While certain embodiments have been described, these embodiments have been presented by way of example only, and are not intended to limit the scope of the inventions. Indeed, the novel systems described herein may be embodied in a variety of other forms; furthermore, various omissions, substitutions and changes in the form of the systems described herein may be made without departing from the spirit of the inventions. The accompanying claims and their equivalents are intended to cover such forms or modifications as would fail within the scope and spirit of the inventions.

What is claimed is:

1. An equalization apparatus configured to receive a digitally modulated single carrier signal and perform multipath equalization in a frequency domain, the equalization apparatus comprising:
a frequency domain conversion unit configured to convert a received time domain signal to a frequency domain signal;
a channel estimation unit configured to estimate a channel response in a frequency domain from the received signal;
an equalization weight calculation unit configured to calculate an equalization weight from the channel estimate value in the frequency domain;
an equalization filter configured to receive the frequency domain signal from the frequency domain conversion unit and the equalization weight from the equalization weight calculation unit as input and perform equalization processing; and
a time domain conversion unit configured to convert the frequency domain signal subjected to the equalization processing by the equalization filter to a time domain signal,
wherein the equalization weight calculation unit comprises:
a power calculation unit configured to calculate a power value of the channel estimate value;
a power value correction unit configured to compare the power value from the power calculation unit with a threshold and output a power value corrected according to the result;
a complex conjugate generator configured to generate a conjugate complex number of the channel estimate value; and
a divider configured to divide the conjugate complex number by the corrected power value and output the division result as an equalization weight.

2. The equalization apparatus according to claim 1, wherein the power value correction unit comprises:
a correction function generator configured to generate a correction function; and
a power corrector configured to correct the power value from the power calculation unit using the correction function, compare the power value from the power calculation unit with a threshold and output, when the power value is smaller than the threshold, a constant value equal to or above the threshold as a corrected power value.

3. The equalization apparatus according to claim 1, wherein the power value correction unit comprises:
a threshold comparator configured to compare the power value from the power calculation unit with a threshold and output a signal indicating whether or not the power value is smaller than the threshold; and
a selector configured to input the power value from the power calculation unit to one input end and input the same value as the threshold used in the threshold comparator to the other input end and select and output any one of the inputs of the two input ends using the comparison result of the threshold comparator as a selected signal.

4. The equalization apparatus according to claim 2, wherein the correction function generator comprises a multipath feature detector and a threshold generator,
the multipath feature detector outputs at least one of an average power value, a maximum power value, a minimum power value and information calculated from the number of ripples using a channel estimate value in the frequency domain, and
the threshold generator generates a threshold using information from the multipath feature detector.

5. The equalization apparatus according to claim 3, further comprising an MER measuring instrument configured to measure a modulation error ratio of the output from the time domain conversion unit,
wherein the power value correction unit comprises a threshold generator configured to correct a threshold of the threshold comparator using information from the MER measuring instrument, and
the threshold generator comprises a storage device configured to store the MER value received from the MER measuring instrument, a comparator configured to compare a previous MER value with a latest MER value in a predetermined cycle and a threshold corrector configured to correct the threshold used for the threshold comparator according to the comparison result.

6. A broadcasting receiving apparatus comprising:
a tuner configured to select and receive a broadcast signal;
a demodulation unit provided with an equalization apparatus, configured to equalize a received signal from the tuner to obtain equalization data, demodulate the equalization data and output transport stream data;
a decoder configured to decode the transport stream data and reproduce a video signal and a speech signal; and
a display unit configured to display/output the video signal and the speech signal,
wherein the equalization apparatus comprises:
a frequency domain conversion unit configured to convert a received time domain signal to a frequency domain signal;
a channel estimation unit configured to estimate a channel response in a frequency domain from the received signal;
an equalization weight calculation unit configured to calculate an equalization weight from the channel estimate value in the frequency domain;
an equalization filter configured to receive the frequency domain signal from the frequency domain conversion unit and the equalization weight from the equalization weight calculation unit as input and perform equalization processing; and
a time domain conversion unit configured to convert the frequency domain signal subjected to the equalization processing by the equalization filter to a time domain signal, and
the equalization weight calculation unit comprises:
a power calculation unit configured to calculate a power value of the channel estimate value;
a power value correction unit configured to compare the power value from the power calculation unit with a threshold and output a power value corrected according to the result thereof;
a complex conjugate generator configured to generate a conjugate complex number of the channel estimate value; and
a divider configured to divide the conjugate complex number by the corrected power value and output the division result as an equalization weight.

7. The broadcasting receiving apparatus according to claim 6,
wherein the power value correction unit comprises:
a correction function generator configured to generate a correction function; and
a power corrector configured to correct the power value from the power calculation unit using the correction function, compare the power value from the power calculation unit with a threshold and output, when the power value is smaller than the threshold, a constant value equal to or above the threshold as a corrected power value.

8. The broadcasting receiving apparatus according to claim 6,
wherein the power value correction unit comprises:
a threshold comparator configured to compare the power value from the power calculation unit with a threshold and output a signal indicating whether or not the power value is smaller than the threshold; and
a selector configured to input the power value from the power calculation unit to one input end and input the same value as the threshold used in the threshold comparator to the other input end and select and output any one of the inputs of the two input ends using the comparison result of the threshold comparator as a selection signal.

9. The broadcasting receiving apparatus according to claim 7,
wherein the correction function generator comprises a multipath feature detector and a threshold generator,
the multipath feature detector outputs at least one of an average power value, a maximum power value, a minimum power value and information calculated from the number of ripples using a channel estimate value in the frequency domain, and
the threshold generator generates a threshold using information from the multipath feature detector.

10. The broadcasting receiving apparatus according to claim 8, further comprising an MER measuring instrument configured to measure a modulation error ratio of the output from the time domain conversion unit,
wherein the power value correction unit comprises a threshold generator configured to correct a threshold of the threshold comparator using information from the MER measuring instrument, and
the threshold generator comprises a storage device configured to store the MER value received from the MER measuring instrument, a comparator configured to compare a previous MER value with a latest MER value in a predetermined cycle and a threshold corrector configured to correct the threshold used for the threshold comparator according to the comparison result.
